(19) United States
(12) Patent Application Publication
(10) Pub. No.: US 2012/0311809 A1
(43) Pub. Date: Dec. 13, 2012

(54) WIPER BLADE, IN PARTICULAR FOR WINDOWS OF MOTOR VEHICLES, AND METHOD FOR PRODUCING A WIPER BLADE

(75) Inventors: Johan Camps, Glabbeek (BE); Jan Van Hoye, Tessenderlo (BE); Peter De Block, Halen (BE); Jochen Weidlich, Rastatt (DE); Martin Kipfmueller, Karlsruhe (DE)

(73) Assignee: Robert Bosch GmbH, Stuttgart (DE)

(21) Appl. No.: 13/578,602

(22) PCT Filed: Feb. 1, 2011
(86) PCT No.: PCT/EP2011/051377

§ 371 Date: Aug. 10, 2012

(30) Foreign Application Priority Data
Feb. 12, 2010 (DE) 10 2010 001 900.3

(51) Int. Cl. B60S 1/40; B32B 37/06

(52) U.S. Cl. 15/250.32; 156/293

(57) ABSTRACT

The invention relates to a wiper blade (10) and to a method for producing a wiper blade (10), in particular for windows of motor vehicles, having a supporting element (12) supporting an elastic wiper strip (14) and at least one spring-loaded spring rail (38) having a connecting device (15) that can connect to a wiper arm (16) directly or by means of an adapter, and that is welded to the at least one spring rail (38) of the supporting element (12). The invention proposes that the connecting device (15) comprises at least one energy directing element (46) on the leg (36) including at least one spring rail (38), said element directing the welding energy to a defined point between the spring rail (38) and the connecting piece (15).

### BACKGROUND OF THE INVENTION

The invention relates to a wiper blade, in particular for windows of motor vehicles, with a supporting element which supports an elastic wiper strip and has at least one spring-elastic spring rail, with a connecting device which can enter into connection with a wiper arm directly or via an adapter and which is welded to the at least one spring rail of the supporting element. In the case of wiper blades of this type, the supporting element is intended to ensure that the wiper-blade contact pressure on the window emanating from the wiper arm is distributed as uniformly as possible over the entire area wiped by the wiper blade. By means of an appropriate curvature of the unloaded supporting element—i.e. when the wiper blade is not resting on the window—the ends of the wiper strip, which rests fully on the window when the wiper blade is in operation, are loaded toward the window by the supporting element, which is then stressed, even if the radii of curvature of spherically curved vehicle windows vary in each position of the wiper blade. The curvature of the wiper blade must therefore be somewhat sharper than the sharpest curvature measured in the wiped area on the window to be wiped. The supporting element thus replaces the complex supporting-bracket structure with two spring rails arranged in the wiper strip, as employed on conventional wiper blades.

The invention starts from a wiper blade of the type described above, as disclosed by DE-A 197 18 490. It has been proposed there that the connecting device encompasses the spring rail of the supporting element and the spring rail is welded to the connecting device in this region.

A drawback of welding of this type is that the welding process parameters have to be very rigidly adhered to in order to withstand the high bending and shearing forces in this region over the surface life of the wiper blade. This causes high additional costs in particular in the case of mass-produced wiper blades.

### SUMMARY OF THE INVENTION

### Advantages of the Invention

The wiper blade with the features of the main claim has the advantage that the input welding energy is concentrated at a defined point and propagates in a defined direction. Therefore, the welding melt in particular is produced in a predeterminable manner and the welding operation is fixed within a time sequence. The welding melt is therefore prevented from arising at any point and, depending on the direction of propagation in the region of the connecting device, times of differing length are required in order to reach the end of the connecting device. The maximum welding time is significantly restricted as a result.

The connecting device can be produced in a simple manner, for example as an injection-molded part, if the limbs engaging around the supporting element has at least one energy director on a side facing the lower side of the supporting element.

The welding energy is input in a particularly simple manner if the energy director is small in relation to the welding surface, in particular if it is configured to be point-shaped. An energy director which is line-shaped only may be advantageous if the limbs extend over a relatively long distance along the supporting element.

It is particularly advantageous if there is a plurality of energy directors, since, as a result, the maximum welding time which is required in order to distribute the welding melt over the required surface can be further reduced. In this case, it is expedient to select the input welding energy to be correspondingly higher than in the case of an individual energy director.

The energy director preferably has a convex, in particular sharp-pointed shape, such that the welding energy is introduced at a precise point. In addition, a connecting device which is produced by injection molding can be removed from the mold in a very simple manner.

It has proven particularly advantageous to provide energy directors in the region of the limbs with an area of approximately one square millimeter. Furthermore, it has proven particularly advantageous if the distance between individual energy directors corresponds approximately to three times the size of the area.

In particular if the connecting device is manufactured from plastic and the spring rails of the supporting element are manufactured from metal, the welding energy can preferably be introduced by means of ultrasonic welding.

Great stability can be achieved if the welding energy is introduced from the upper side of the supporting element. It has proven advantageous if the connecting device has, in the region of the upper side of the supporting element, at least one aperture through which into the welding energy is introducible. The stability can be further increased if at least one energy director lies opposite the aperture.

The installation of the wiper blade which is not yet curved is simplified if the limb or the limbs engages or engage around the rail of the supporting element with play. The limb may be formed with a mash seam which has the form of an elevation in the direction of the spring rail and which can also be used as an energy director.

If a melt flow channel is provided, the process reliability can be improved if the flow of the welding melt can be deflected or stopped. The melt flow channel preferably runs along a longitudinal extent of the rail.

The installation can be further simplified if the connecting device has, in the region of the at least one limb, an insertion slope for easier insertion of the at least one rail.

It has been shown that the welding energy can be input particularly reliably if the height of the energy directors corresponds to 30% to 80% of the thickness of the spring rail. It is particularly advantageous if, in the case of a spring rail of between 0.8 mm and one millimeter, the energy director or energy directors have a height of approximately 0.5 mm.

A cost-effective wiper blade is produced if the connecting device is at least partially composed of a plastic, in particular a thermoplastic. The connecting device is welded particularly well to the supporting element if the spring rails are converted with a plastic, in particular a thermoplastic.

The invention also relates to a method for producing a wiper blade, which is characterized by the following steps. First of all, one or more spring rails is or are pushed into a connecting device which has one or more energy directors for the welding energy one at least one limb. The welding energy is then introduced in such a manner that the energy flux propagates from the energy director, and the welding proceeds in a controlled and predetermined manner.

### BRIEF DESCRIPTION OF THE DRAWINGS

A plurality of exemplary embodiments of the wiper blade according to the invention are illustrated in the drawings and explained in more detail in the description below. In the drawings:

FIG. 1 shows a wiper blade in an oblique view,

FIG. 2 shows a section along the line II-II in FIG. 1,

FIG. 3 shows a partial section along the line III in FIG. 2,

FIGS. 4a-c and 5 show exemplary embodiments of energy directors,

FIGS. 6 and 7 show part of a limb of the connecting device,

FIG. 8 shows a connecting device in an ultrasonic welding device, and

FIG. 9 shows an alternative to FIG. 8.

### DETAILED DESCRIPTION

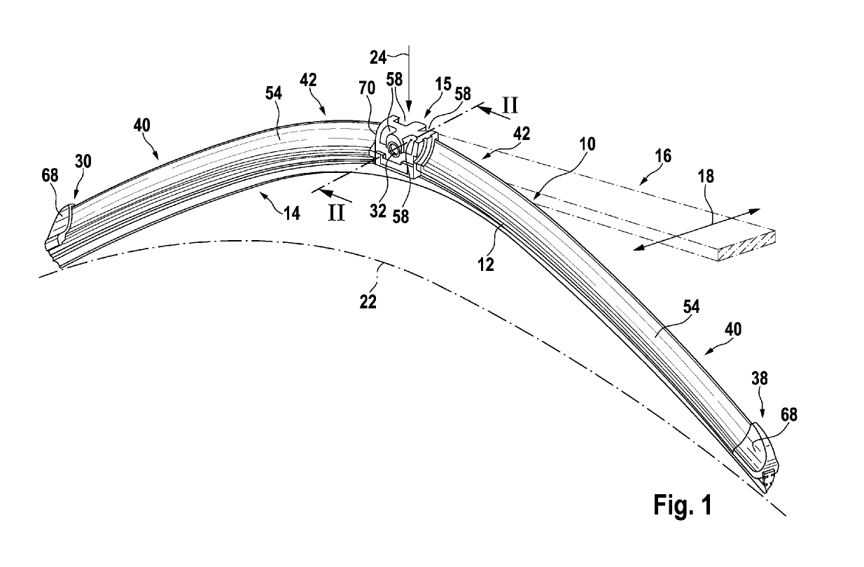

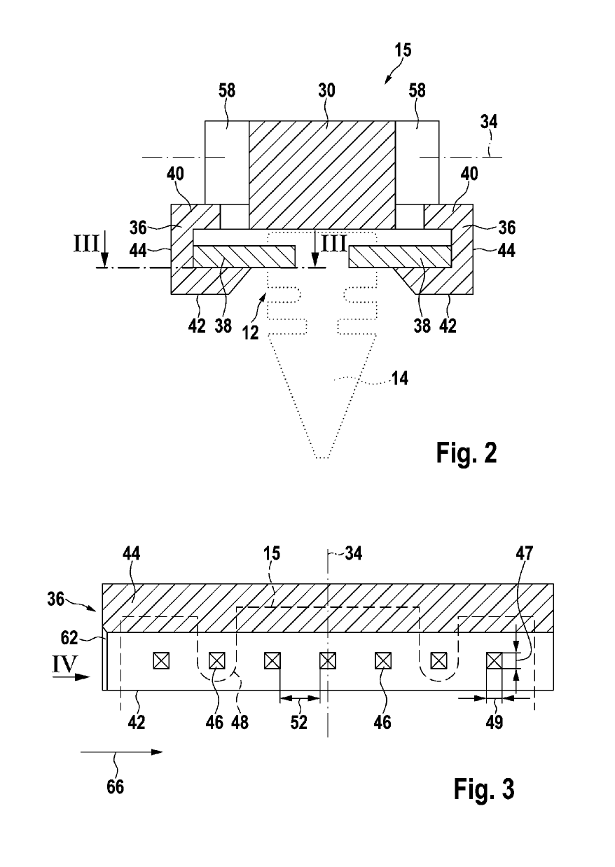

A wiper blade 10 shown in FIG. 1 has a spring-elastic supporting element 12 (FIGS. 1 and 2), which is elongate in the manner of a band and on the lower, concave band side 13 of which, which side faces the window, an elongate rubber-elastic wiper strip 14 is fastened parallel to the longitudinal axis. Arranged on the upper, convex band side 11, which side faces away from the window, of the supporting element 12, which may also be referred to as a spring rail, in the central section of the latter, is a wiper-blade-side connecting device 15, with the aid of which the wiper blade 10 can be connected releasably in an articulated manner to a wiper arm 16, indicated by chain-dotted lines in FIG. 1. The wiper arm 16, which is driven in an oscillating manner in the direction of a double arrow 18 in FIG. 1, is loaded in the direction of an arrow 24 toward the window to be wiped—for example toward the windshield of a motor vehicle—the surface of which is indicated by a chain-dotted line 22 in FIG. 1. Since the line 22 is intended to indicate the sharpest curvature of the window surface, it is clearly apparent that the curvature of the as yet unloaded wiper blade, which rests with the two ends thereof on the window, is sharper than the maximum curvature of the window (FIG. 1). Under the contact pressure (arrow 24), the wiper blade 10 comes to rest by means of the wiper lip 26 thereof over the entire extent thereof against the window surface 22. At the same time, a stress builds up in the spring-elastic supporting element 12, which is manufactured from metal, said stress ensuring proper contact of the wiper strip 14 or of the wiper lip 26 over the entire length thereof with the window surface 22 and uniform distribution of the contact pressure (arrow 24).

The special configuration of the wiper blade according to the invention will now be discussed in more detail below. In FIG. 2, the connecting device 15 is shown in section. It has a basic body 30 which has a pin socket 32 (FIG. 1) which is illustrated in FIG. 2 by means of the axis 34 thereof. Two opposite limbs 36 of U-shaped configuration in cross section, the U openings of which face each other, are integrally formed on the basic body 30. This produces a cavity in which two spring rails 38 of the supporting element 12 are mounted, said spring rails, for their part, receiving the wiper strip 14 therebetween.

In the exemplary embodiment, the limbs 36 are in the form of strips and extend over the entire length of the connecting device 15. They have upper strips 40 which are connected to the basic body 30, and light 42 opposite the basic body 30 and also webs 44 connecting the upper strips 40 to the lower strips 42. In alternative forms, however, the limbs 36 may also be designed in the manner of collars and only partially extend along the connecting device.

FIG. 3 illustrates part of a limb 36 in the direction of the line along III in FIG. 2, wherein the welding between the connecting device 15 and supporting element 12 has not yet taken place and therefore energy directors 46 can be seen. The energy directors 46 are arranged on the lower strip 42 in such a manner that they point in the direction of the spring rail 38 opposite thereto. In the exemplary embodiment, seven energy directors 46 are arranged uniformly over the length of the lower strip 42. However, it is also conceivable to provide only one individual energy director 46 which is then optimally placed by itself the.

As can be seen in FIG. 3, the surface of both the individual energy director 46 and of the sum but energy directors 46 are small in relation to the surface of the lower strip 42. This also applies to the overlapping region between the lower strip 42 and the spring rail 38 opposite thereto.

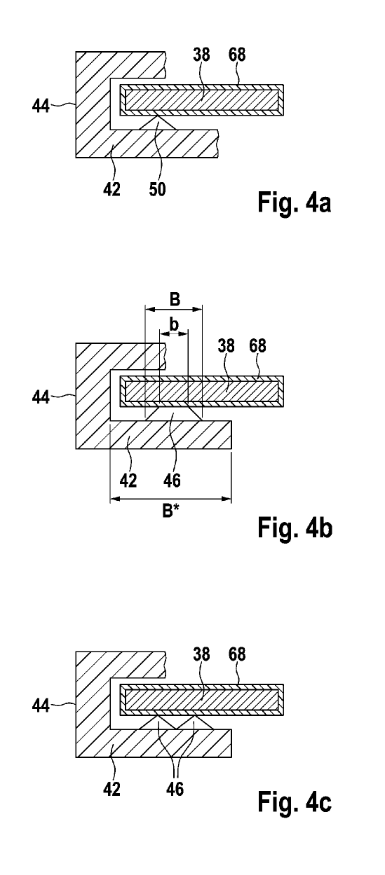

The energy director 46 is approximately square in the area 48 thereof and has a pyramidal elevation 50, as can also be seen in FIG. 4a. Each side length of the area is approximately 1 mm, and the height of the pyramid is approximately 0.5 mm. FIG. 4b shows a design in the shape of a truncated pyramid, in which the width b of the small surface is small in relation to the width B of the area which, in turn, is small relative to the width B* of the strip 42. It is illustrated in FIG. 4c that the energy direction transmitters 42 can also be arranged next to one another in pairs. In an extreme case, there is an arrangement of a multiplicity of energy directors resulting in texturing of the surface.

As can be seen in FIG. 5, the elevation 50 may also be shaped convexly, in particular in the form of a semicircle. The first contact between the energy director 46 and the spring rails 38 may therefore be considered to be a point-shaped contact or at least contact with a small area.

The distance 52 between two energy directors 46 is approximately three times the size of the side lengths 47, 49 of the area 48 and, in the exemplary embodiment, is therefore approximately 3 mm. The size of and distance between the energy directors 46 are dependant on the welding energy which is to be input and which, for its part, should be selected to be higher, the shorter the available welding time selected.

In an extreme case, the energy director 46 may be of line-shaped design, as illustrated in FIG. 7. It can also be seen there that, as seen in cross section, the energy director 46 may be of triangular design. Depending on the further geometrical conditions within the U shape of the limbs 36 and the thickness of the spring rails 38, the energy director 46, and in particular the line-shaped energy director 46, can act as a mash seam, that is to say, the spring rails 38, after being introduced into the limbs 36, are retained in the limbs 38 in a light press fit by means of the mash seam. The line-shaped energy direction transmitter may also be designed in the shape of a truncated pyramid. The energy direction transmitters may also occur in this case in pairs.

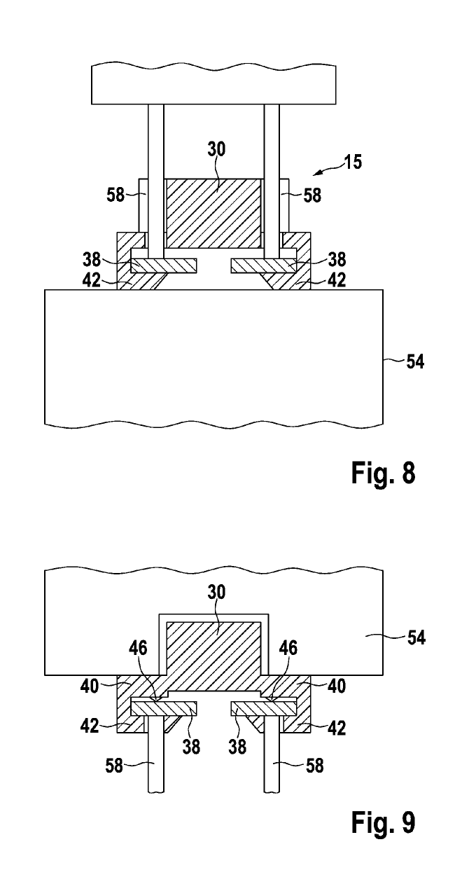

FIG. 8 illustrates how the connection between the connecting device 15 and the spring rails 38 is produced. In this case, the connecting device 15 rests with both of the lower strips 42 thereof on an anvil 54 while the welding energy is input from above in the form of ultrasound. For this purpose, the basic body 30 and the upper strips 40 have cutouts 58 through which sonotrodes 60 reach as far as the upper sides of the spring rails 38 and input the ultrasonic energy thereof into the spring rails. The ultrasonic waves pass through the spring rails 38, which are generally retained in metal, and pass on the lower side thereof onto the tips of the energy directors 46. From there, the heat which is generated in a spot-like manner is introduced into the lower strip 42 and distributed.

It has turned out that it is particularly favorable if at least one energy director 46 lies directly below each cutout 48 and therefore directly below the sonotrode 60. Starting from said exposed energy directors 46, the melt flux propagates in a cascade-shaped manner along the further energy directors 46 on the lower strip 42.

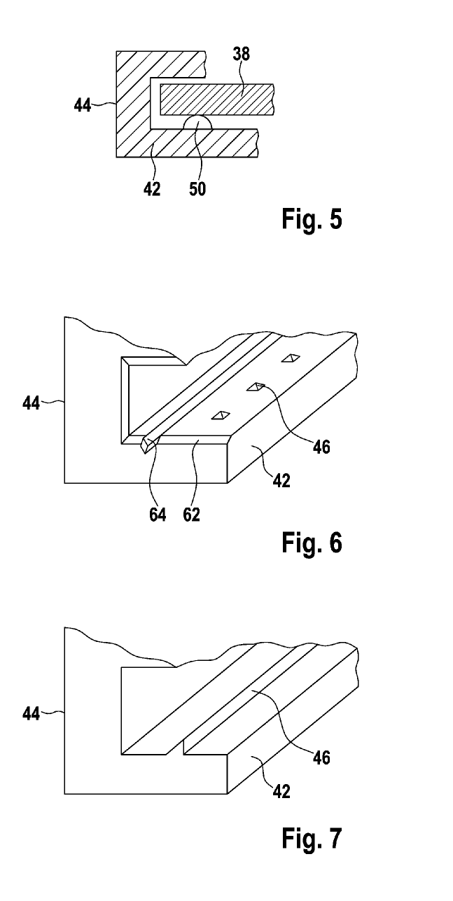

In order to conduct the melt flux even better, a melt flux channel 64 can be provided, as illustrated in an alternative in FIG. 6. Said melt flux channel 64 prevents excessive flowing off of the melt flux in the direction of the webs 44 and improves the flux along the lower strip 42. In general, it is sufficient to provide the depth of the melt flux channel 64 in a manner corresponding to the height of the energy directors 46.

The height of the energy directors 46 should be selected within a range of between 30% and 80% of the thickness thereto welding to move the spring rail 38 and will provide in the case of rails from 0.8 mm to 1 mm, preferably at 0.5 mm.

As a rule, the limbs 36 engage around the spring rails 38 of the supporting element 12 with play, and therefore the spring rails 38 can easily be inserted into the limbs 36. If, however, as described further above, use is made of a mash seam, the insertion is made difficult. An insertion slope 62 in the region of the limbs 36 makes it easier. The direction of fitting of the spring rails 38 into the limbs 36 is then along the arrow 66.

In the exemplary embodiment, the connecting device 15 is manufactured from a thermoplastic and is preferably produced in the form of an injection-molded part. The spring rails 38 are generally composed of steel and can have an encasing 68, as indicated in FIG. 4. Said encasing 68 serves to protect the spring rail 38 and for better welding behavior between the spring rail 38 and lower strip 42. The encasing 68 may likewise be composed of a thermoplastic.

In the case of the method according to the invention for producing a wiper blade 10, the spring rails 38 are first of all pushed into the limbs 36 of the connecting device 15 and are fixed in the position to be welded on an anvil 54 of an ultrasonic welding installation. Four sonotrodes 60 are then moved into the four cutouts 58 until they rest on the upper side of the spring rails 38. Under pressure of the sonotrodes 60 against the spring rails 38, the ultrasonic energy is input into the spring rail 38. The sound waves pass through the spring rail 38, strike against the tips of the energy directors 46 and begin to melt the latter. Starting therefrom, the plastic of the lower strips 42 is heated and forms a melt. The melt flux extends from the energy directors 46 and is conveyed by the pressure used uniformly over that surface of the lower strip 42 which faces the spring rail 38 and can be focused with the aid of a melt flux channel 64.

The supply of ultrasonic energy is stopped and, as soon as the curing of the melt flux begins, the pressure of the sonotrodes 60 against the spring rails 38 is reduced and the sonotrodes 60 are moved out of the cutouts 58. The spring rails 38 and therefore the supporting element 12 are fixedly connected to the connecting device 15, and further elements, such as the wiper strip 14 and optionally the spoiler and end caps, can be added.

It is also conceivable not to input the energy by means of ultrasound but rather by means of laser, wherein transmission and absorption coefficients of the connecting device 15 and of the spring rails 38 or modifications 68 thereof are coordinated with the laser wavelength in such a manner that heat is first generated in the region of the energy directors 46.

1. A wiper blade, with a supporting element (12) which supports an elastic wiper strip (14) and has at least one spring-elastic spring rail (38), with a connecting device (15) which is configured to enter into connection with a wiper arm (16) directly or via an adapter and which is welded to the at least one spring rail (38) of the supporting element (12), characterized in that the connecting device (15) has at least one energy director (46) on a limb (36) encompassing at least one spring rail (38), said energy director directing the welding energy to a defined point between the spring rail (38) and the connecting device (15).

2. The wiper blade as claimed in claim 1, characterized in that the supporting element (12) has a convex upper side and a concave lower side, and in that each limb (36) has at least one energy director (46) on a side facing the lower side of the supporting element (12).

3. The wiper blade as claimed in claim 1, characterized in that the energy director (46) is small in relation to a welding surface.

4. The wiper blade as claimed in claim 1, characterized in that the energy director (46) is point-shaped.

5. The wiper blade as claimed in claim 1, characterized in that the energy director (46) is in the shape of a truncated pyramid.

6. The wiper blade as claimed in claim 1, characterized in that the energy director (46) is line-shaped.

7. The wiper blade as claimed in claim 1, characterized in that the connecting device has a plurality of energy directors (46).

8. The wiper blade as claimed in claim 1, characterized in that the energy director (46) has a convex shape.

9. The wiper blade as claimed in claim 1, characterized in that the energy director (46) on the limb (36) has an area (48) of approximately one square millimeter.

10. The wiper blade as claimed in claim 1, characterized in that a distance (52) between individual energy directors (46) is essentially three times the size of an area (48) of one energy director (46).

11. The wiper blade as claimed in claim 1, characterized in that the welding energy is introduced by means of ultrasonic welding.

12. The wiper blade as claimed in claim 1, characterized in that the welding energy is introduced from an upper side of the supporting element (12).

13. The wiper blade as claimed in claim 1, characterized in that the connecting device (15) has, in a region of an upper side of the supporting element (12), at least one cutout (58) through which the welding energy is introducible.

14. The wiper blade as claimed in claim 13, characterized in that at least one energy director (46) lies opposite the cutout (58).

15. The wiper blade as claimed in claim 1, characterized in that the limb (36) engages around the spring rail (38) of the supporting element (12) with play.

16. The wiper blade as claimed in claim 1, characterized in that at least one mash seam in the form of an elevation in a direction of the spring rail (38) is provided on the limb, which mash seam may also be used as the energy director (46).

17. The wiper blade as claimed in claim 1, characterized in that at least one melt flow channel (64) is provided for one of conducting and retaining welding melt.

18. The wiper blade as claimed in claim 17, characterized in that the melt flow channel (64) runs along a longitudinal extent of the spring rail (38).

19. The wiper blade as claimed in claim 1, characterized in that the connecting device (15) has, in a region of the at least one limb (36), an insertion slope (62) facilitating insertion of the at least one spring rail (38).

20. The wiper blade as claimed in claim 1, characterized in that a height of the energy directors (46) corresponds to 30% to 80% of a thickness of the spring rail (38).

21. The wiper blade as claimed in claim 1, characterized in that the connecting device (15) is at least partially composed of a plastic.

22. The wiper blade as claimed in claim 1, characterized in that the spring rail (38) is encased with a plastic.

23. A method for producing a wiper blade as claimed in claim 1, the method comprising:
pushing one or more spring rails (38) into a connecting device (15), and
introducing welding energy into the one or more spring rails (38) through at least one cutout (58) in the connecting device (15) such that, by means of at least one energy director (46), the welding energy welds at least one limb (36) of the connecting device (15) to a lower side of the supporting element (12) in a predetermined manner.

24. The wiper blade as claimed in claim 1, characterized in that the energy director (46) has a sharp-pointed shape.
